(19) United States
(12) Patent Application Publication
(10) Pub. No.: US 2006/0141274 A1
(43) Pub. Date: Jun. 29, 2006

(54) Sealing film comprising a barrier layer

(76) Inventors: Gunter Schubert, Rheinbach (DE); Uli Grafmuller, Malterdingen (DE); Guy Boiron, Wintzenheim (FR)

Correspondence Address: PROSKAUER ROSE LLP;PATENT DEPARTMENT, 1585 BROADWAY, NEW YORK, NY, 10036-8299, US

(21) Appl. No.: 10/522,221

(22) PCT Filed: Jul. 23, 2003
(86) PCT No.: PCT/EP03/08017

§ 371 Date: Jan. 31, 2006

(30) Foreign Application Priority Data
Aug. 3, 2002 (DE) 102 35 583.5

(51) Int. Cl. B32B 27/34; B32B 27/36

(52) U.S. Cl. 428/474.4; 428/480

(57) ABSTRACT

The invention relates to a sealing foil with a substrate (2), a primer layer (3) and at least one extruded functional layer (6). Such a sealing foil is improved with a view to suppressing migration in that between the primer layer (3) and the extruded functional layer (6) an extruded barrier layer (4) is provided which prevents at least the migration of components of the primer layer (3) and/or of the functional layer (6).

The invention relates to a sealing foil with a substrate, a primer layer and at least one extruded functional layer.

As a rule, sealing foils whose substrates comprise for example aluminium, plastic or paper have a primer layer as an adherent surface for extrusion coatings. The functional layers applied by extrusion are for example weld layers, seal layers or peel layers.

In particular, if cross-linking 2K primers are used as an adherent surface for extrusion coatings, there is a danger of undesirable migration occurring between the extrusion coatings and the primer layer. Components of the primer which can migrate, which components can occur as long as the primer is not yet cross-linked or has not reacted, can cause interference with the properties of the functional layers (weld, seal or peel properties) or interference with additive functions such as for example sliding properties or antistatic properties. Furthermore, interference with, or changes in, the primer curing and/or primer properties or interfacial bonding may occur. Such migration occurs in particular if functionalised polymers, copolymers and/or blends with low cristallinity, incompatible components and/or greater solubility are used for migrateable components. As a rule, these polymers have a greater tendency to migrate than non-modified polymers, as is for example documented by the difference in lubricant migration in polyethylene or its copolymers. In particular, peelable functional layers are very receptive to migration, permeability, solubility and diffusivity.

Based on the state of the art described above, it is the object of the present invention to provide a sealing foil in which undesirable migration of components of the primer layer and/or the functional layer which have/has a negative effect of the packaging function are/is avoided.

According to the invention, the previously derived and shown object is met in that between the primer layer and the extruded functional layer an extruded barrier layer is provided which prevents at least the migration of components of the primer layer and/or of the functional layer. By arranging such a barrier layer between the primer layer and the functional layer, migration within the composite structure is at least reduced as a result of which a sealing foil is provided which is simple to produce and which makes it possible to use primer systems with fast curing rates or with good adhesive properties, which primer systems could not hitherto be used because of their increased tendency to migrate.

For example, because of shorter curing times of the primer, this sealing foil provides improved economy and improved and enhanced product safety.

By the barrier layer according to a first embodiment comprising good properties of adhering to the primer layer, the layer system according to the invention can be provided in a very simple way.

If the adhesive properties of the barrier layer on the primer layer cannot easily be reconciled with the barrier effect, then for the purpose of bringing about the adhesive properties, advantageously a bonding agent layer is provided between the primer layer and the barrier layer.

The provision of a compatibility agent layer between the barrier layer and the functional layer clearly expands the spectrum of the materials which can be used for the barrier layer.

Extrusion coating in a single work step is ensured by the barrier layer and/or the bonding agent layer and/or the compatibility agent layer according to an advantageous embodiment of the invention being coextruded with the functional layer.

The barrier plastic for producing the barrier layer provided according to the invention is to be selected in a targeted way according to the expected migrateable components of the layers. In particular polyethylene of increased density, polyester, polyamide or a filled polymer is suitable as a polymer for the barrier layer provided according to the invention.

There are a multitude of possibilities of designing and improving the sealing foil according to the invention. To this effect we refer for example on the one hand to the subordinate claims of claim 1, and on the other hand to the description of a preferred embodiment in conjunction with the drawing.

In the drawing, the sole FIGURE shows a section through an embodiment of a sealing foil according to the invention.

The embodiment, shown in the sole FIGURE, of a sealing foil 1 according to the invention comprises a substrate 2, which in the embodiment shown comprises aluminium. This substrate 2 comprises a primer layer 3 as an adherent surface for the extrusion coating. As an alternative, the substrate can for example also comprise a polyester film.

In the embodiment shown, extrusion coating has taken place by coextruding a barrier layer 4 provided according to the invention, a compatibility agent layer 5, and a functional layer 6.

In order to improve or modify the adhesive properties between the primer layer 3 and the barrier layer 4, a bonding agent layer (not shown), arranged between said two layers, can additionally be used, with said bonding agent layer preferably being coextruded with the barrier layer 4, the compatibility agent layer 5 and the functional layer 6.

The arrangement according to the invention of a barrier layer 4 between the primer layer 3 and the functional layer 6 has an additional effect in that under certain circumstances expensive functional layers, for example comprising peel mixtures, can at least partially be replaced by the relatively more economical barrier material.

Unlike the embodiment of a sealing foil 1 according to the invention, shown in the embodiment depicted in the sole FIGURE, it is possible to use two or several functional layers instead of, as shown, only one functional layer 6, in order to adapt the sealing foil 1 according to the invention to its purpose of application.

1. A sealing foil with a substrate, a primer layer and at least one extruded functional layer wherein
between the primer layer and the extruded functional layer an extruded barrier layer is provided which prevents at least the migration of components of the primer layer and/or of the functional layer.

2. The sealing foil according to claim 1, wherein
the barrier layer has good properties of adhering to the primer layer.

3. The sealing foil according to claim 1, wherein
a bonding agent layer is provided between the primer layer and the barrier layer.

4. The sealing foil according to claim 1, wherein
between the barrier layer and the functional layer a compatibility agent layer is provided.

5. The sealing foil according to claim 1, wherein
the barrier layer and/or the bonding agent layer and/or the compatibility agent layer are coextruded with the functional layer.

6. The sealing foil according to claim 1, wherein
the barrier layer comprises, at least in part, polyethylene of increased density, polyester, polyamide or a filled polymer.
